(19) United States
(12) Patent Application Publication
(10) Pub. No.: US 2012/0007714 A1
(43) Pub. Date: Jan. 12, 2012

(54) SEWER PIPE REPAIR LINER WITH RADIO-FREQUENCY IDENTIFICATION TRANSPONDER AND METHOD OF USING SAME

(76) Inventor: Michael Mühlin, Erkelenz (DE)

(21) Appl. No.: 12/831,654

(22) Filed: Jul. 7, 2010

(51) Int. Cl. G06K 7/01; F16L 55/162

(52) U.S. Cl. 340/10.1; 138/98

(57) ABSTRACT

A repair liner for repairing a lateral/main pipe junction and method of using the same to identify a lateral sewer pipe are disclosed. The repair liner includes a radio-frequency identification transponder capable of transmitting an identification signal that is unique to the repair liner. The method comprises the steps of: Providing a repair liner for repairing a lateral/main pipe junction, the repair liner including a radio-frequency identification transponder capable of transmitting a identification signal that is unique to the repair liner; bonding the repair liner to one or both of lateral and main sewer pipes at a lateral/main pipe junction, whereby the radio-frequency identification transponder is positioned proximate the lateral/main pipe junction; providing a mobile device for moving in the main sewer pipe, the mobile device including a radio-frequency identification reader capable of detecting the identification signal transmitted by the radio-frequency identification transponder when the mobile device is positioned proximate the radio-frequency identification transponder; and moving the mobile device in the main sewer pipe so that the mobile device is positioned proximate the radio-frequency identification transponder so as to detect the identification signal transmitted by the RFID transponder.

### FIELD OF THE INVENTION

The present disclosure relates generally to sewer pipe repair liners, and more particularly to such repair liners comprising a radio-frequency identification (“RFID”) transponder.

### BACKGROUND

It is conventional in the repair of sewer pipes at the junction between the main pipe and lateral pipes branching therefrom toward various buildings to employ a resin-impregnated, fibrous repair liner that is cured in place at each lateral/main pipe junction needing repair. Typically, the repair liner is introduced to the repair site via the main pipe by means of a mobile unit commonly referred to as a packer.

It is also conventional in the repair of such lateral/main pipe junctions to move a video camera through the main pipe to help identify the location of both junctions in need of repair as well as previously repaired junctions. However, identification of such pipe junctions, as well as the buildings with which the lateral pipes are ultimately associated, can be difficult, including because many lateral pipes do not follow straight-line paths. To address this problem, it is known to apply printed indicia, such as the address of the building associated with a given lateral/main pipe juncture, to the repair liner. These printed indicia are, more particularly, applied to a surface of the repair liner so as to be visible to the video camera moved through the main pipe. In respect of the foregoing, the disclosure of U.S. Pat. No. 7,588,054, incorporated herein by reference in its entirety, is exemplary.

### SUMMARY

The specification discloses a repair liner for repairing a lateral/main pipe junction, as well as a method of employing such a repair liner to identify specific lateral/main pipe junctions. The repair liner includes a RFID transponder capable of transmitting an identification signal that is unique to the repair liner, thus facilitating easy, repeatable and reliable identification of the repair liner without reliance on visual inspection and identification.

According to one feature, the repair liner may be made of a flexible material impregnable with an uncured resinous material capable of curing and hardening to thereby bond the repair liner to one or both of lateral and main sewer pipes.

In one embodiment, the repair liner comprises a cylindrical sleeve for lining a circumferential portion of the lateral sewer pipe, and an annular collar projecting radially outwardly from the sleeve for lining a portion of the main pipe proximate the main/lateral junction. According to this embodiment, the RFID transponder may be disposed on the annular collar of the repair liner, being secured to a surface of the repair liner, such as by means of adhesives or fastening means, or, alternatively, being embedded within the flexible material of the repair liner.

In another embodiment, the repair liner comprises a cylindrical sleeve for lining a circumferential portion of the lateral sewer pipe, and a cylindrical sleeve for lining a circumferential portion of the main pipe proximate the main/lateral junction. According to this embodiment, the RFID transponder may be disposed on the cylindrical sleeve for lining a circumferential portion of the main pipe, being secured to a surface of the repair liner, such as by means of adhesives or fastening means, or, alternatively, being embedded within the flexible material of the repair liner.

The inventive method for identifying a lateral sewer pipe that forms a pipe junction with a main sewer pipe comprises the steps of:
Providing a repair liner for repairing a lateral/main pipe junction, the repair liner including a RFID transponder capable of transmitting an identification signal that is unique to the repair liner;
bonding the repair liner to one or both of lateral and main sewer pipes at a lateral/main pipe junction, whereby the RFID transponder is positioned proximate the lateral/main pipe junction;
providing a mobile device for moving in the main sewer pipe, the mobile device including a RFID reader capable of detecting the identification signal transmitted by the RFID transponder when the mobile device is positioned proximate the RFID; and
moving the mobile device in the main sewer pipe so that the mobile device is positioned proximate the RFID transponder so as to detect the identification signal transmitted by the RFID transponder.

The repair liner of this method may be any embodiment of the inventive repair liner as described herein.

Per one feature of this method, the mobile device may be a packer for applying a repair liner to a lateral/main pipe junction.

### DESCRIPTION OF THE DRAWINGS

For a better understanding of the present invention and to show more clearly how it may be carried into effect, reference will now be made, by way of example, to the accompanying drawings, in which:

FIG. 1 is a cross-sectional view of a sewer pipe lateral/main pipe junction, showing the inventive repair liner with an RFID transponder, as well as the mobile device with an RFID reader; and

FIG. 2 is a perspective view of a “top hat” type repair liner including an RFID transponder.

### DESCRIPTION

As required, a detailed description of exemplary embodiments of the present invention is disclosed herein. However, it is to be understood that the disclosed embodiments are merely exemplary of the invention, which may be embodied in various and alternative forms. The accompanying drawings are not necessarily to scale, and some features may be exaggerated or minimized to show details of particular components. Therefore, specific structural and functional details disclosed herein are not to be interpreted as limiting, but merely as providing a representative basis for teaching one skilled in the art to variously employ the present invention.

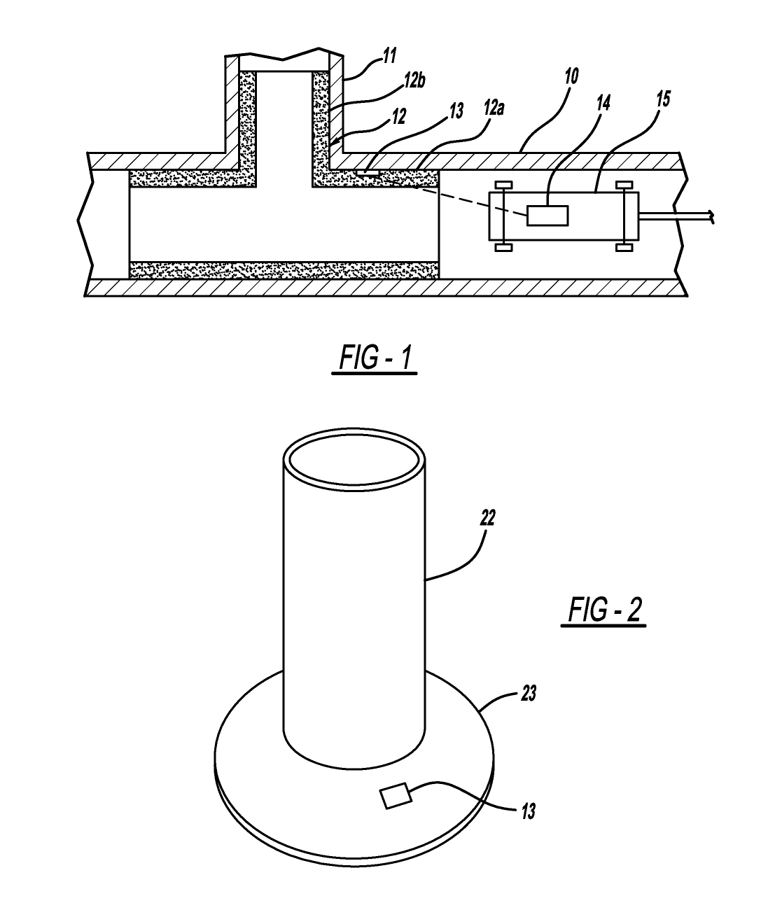

Referring to the FIGS. 1 and 2, the present invention will be seen to generally comprise a repair liner 12 for repairing the junction between main 10 and lateral 11 pipes in a sewer system, the repair liner 12 including a RFID transponder 13 capable of transmitting an identification signal that is unique to the repair liner.

The RFID transponder 13 may be of conventional construction, while the identification signal may be any signal that is unique to the repair liner with which it is associated, including, by way of example, a signal identifying a building (such as, for instance, by address) associated with the lateral pipe 11 in the lateral/main junction of which the repair liner 12 is installed.

RFID technology is known and understood by those skilled in the art, and a detailed explanation thereof is not necessary for purposes of describing the present invention. Generally, RFID transponders, or “tags,” consist of a semiconductor, a coiled, etched, or stamped antennae, a capacitor, and a substrate on which the components are mounted or embedded. A protective covering is typically used to encapsulate and seal the substrate. RFID transponders may be active, semi-passive, or passive, the active and semi-passive varieties distinguished by internal batteries to power their circuits, and the passive variety relying on the RFID reader as the power source. A detailed description of passive RFID “tags” may be found in U.S. Pat. No. 6,259,367 B1, incorporated herein by reference in its entirety. Further information on RFID “tags” and related technology is disclosed in U.S. Pat. No. 6,451,154, “RFID Manufacturing Concepts,” issued Sep. 17, 2002 to Grabau et al.; U.S. Pat. No. 6,354,493, “System and Method for Finding a Specific RFID Tagged Article Located in a Plurality of RFID Tagged Articles,” issued Mar. 12, 2002 to Mon; PCT publication WO 02/48955, published Jun. 20, 2002; U.S. Pat. No. 6,362,738, “Reader for Use in a Radio Frequency Identification System and Method,” issued Mar. 26, 2002 to Vega. All of the foregoing are incorporated herein by reference in their entireties.

Commercial sources of suitable RFID “tags” include Alien Technology Corporation of Morgan Hill, Calif., sold under the name FSA (Fluidic Self-Assembly). With the FSA process, tiny semi-conductor devices are assembled into rolls of flexible plastic. The resulting “smart” substrate can be attached or embedded in a variety of surfaces. Other RFID technologies suited to the present invention include, by way of example and not limitation, the I*CODE chips and readers of Philips Semiconductor (Eindhoven, The Netherlands), and those produced by Texas Instruments (Dallas, Tex.) as part of Texas Instruments RFID (TI*RFID) Systems, formerly known as the TIRIS system (Texas Instruments Registration and Identification System), which is used to track and identify various assets using devices such as the TI TAG IT chip.

The repair liner 12 may be of any conventional manufacture, although in the illustrated embodiment the liner comprises a flexible material, such as felt, for instance, impregnable with an uncured resinous material capable of curing and hardening to thereby bond the repair liner to one or both of lateral 11 and main 10 sewer pipes per conventional practice. Such repair liners and means for their constructions and use in the repair of sewer pipes are all known to those skilled in the art. By way of non-limiting example, for instance, reference is made to the disclosures of U.S. Pat. No. 5,927,341, U.S. Pat. No. 6,068,725, and U.S. Pat. No. 6,044,867, the disclosures of which are incorporated herein by reference in their entireties.

The repair liner 12 may take such form as is appropriate to the repair being effected, the particular form of the repair liner 12 not being limiting of the present invention in its broader scope. In the illustrated embodiment of FIG. 2, by way of example, the repair liner may be a “top hat” style liner comprised of a cylindrical sleeve 22 for lining a circumferential portion of the lateral sewer pipe 11, and an annular collar 23 projecting radially outwardly from the sleeve 22 for lining a portion of the main pipe 10 proximate the main/lateral junction. Per this embodiment, as shown, the RFID transponder 13 is disposed on the annular collar 23 of the repair liner. This may be accomplished by securing the RFID transponder 13 to the collar 23 by such means as adhesives, by sewing or stitching the RFID transponder to the material of the liner, or by fastening the RFID transponder to the material of the liner by staples, rivets, etc. Alternatively, the RFID transponder 13 may be embedded within the material of the repair liner, such as, for instance, by being sandwiched between layers of material where the collar, for example, is comprised of multiple layers, or by creating a slit or other opening in the material of the repair liner and inserting the RFID transmitter therein.

In an alternative embodiment, shown in FIG. 1, repair liner 12 takes the form of a cylindrical sleeve 12b for lining a circumferential portion of the lateral sewer pipe 11, and a cylindrical sleeve 12a for lining a circumferential portion of the main pipe 10 proximate the main/lateral junction. Per this embodiment, as shown, the RFID transponder 13 is disposed on the cylindrical sleeve 12a of the repair liner. As with the embodiment of FIG. 2, this may be accomplished by securing the RFID transponder 13 to the cylindrical sleeve 12a by such means as adhesives, by sewing or stitching the RFID transponder to the material of the liner, by fastening the RFID transponder to the material of the liner by staples, rivets, etc., or, alternatively, by embedding the RFID transponder 13 within the material of the repair liner, such as, for instance, by being sandwiched between layers of material where the collar, for example, is comprised of multiple layers, or by creating a slit or other opening in the material of the repair liner and inserting the RFID transmitter therein.

In use, the repair liner as heretofore described is positioned at a lateral/main pipe junction to be repaired and bonded in place to create a rigid patch, all in known fashion. Thereafter, a mobile device 15 is provided for moving in the main sewer pipe 10, the mobile device 15 including a RFID reader 14 capable of detecting the identification signal transmitted by the RFID transponder 13 when the mobile device is positioned proximate the RFID transponder. Mobile device 15 may be a packer or an apparatus having detection of RFID transponder identification signals as its sole utility. One exemplary packer, for instance, is disclosed in Applicant's U.S. Pat. No. 7,631,665, the disclosure of which is incorporated herein by reference in its entirety.

The RFID reader 14 may be of conventional construction, according to one example of which the reader 14 generates a high-frequency electromagnetic field which is decoded by the RFID transponder 13 when the same is proximate the reader 14. In turn, the RFID transponder 13 generates the unique identification signal that is detected by the reader 14. This detected signal can then be relayed from the mobile device 15 to a remote station (not shown), such as a computer terminal, by means of electrical cable 16 trailing from the device 15 and communicating with the remote station.

Because the signal is unique to the repair liner 12 with which the RFID transponder 13 is associated, it will be appreciated that the invention as so described permits the easy and accurate determination of any given repair liner 12 and its associated lateral/main pipe junction.

It will be appreciated from the foregoing that the multiple inventive repair liners 12 as herein described may be provided in a given sewer line, each positioned in a different lateral/main pipe juncture that is uniquely identified by the RFID transponder 13 associated with each such liner. Furthermore, it will be appreciated from the foregoing that each such repair liner 12 may be separately identified by the mobile device 15 as it moves along the main pipe 10 of the sewer line and into proximity with each successive RFID transponder 13.

The foregoing description of the exemplary embodiment of the invention has been presented in order to explain the principles of the innovation and its practical application so as to enable one skilled in the art to utilize the innovation. It is not intended to be exhaustive of, or to limit the invention to, the precise forms disclosed, and although only an exemplary embodiment of the present invention has been described in detail in this disclosure, those skilled in the art who review this disclosure will readily appreciate that many modifications are possible to the present invention without materially departing from the novel teachings and advantages of the subject matter herein recited. Other substitutions, modifications, changes and omissions may be made in the exemplary embodiment without departing from the spirit of the present invention and, accordingly, all such modifications, changes, etc. are intended to be included within the scope of the invention as hereinafter claimed.

1. A method for identifying a lateral sewer pipe that forms a pipe junction with a main sewer pipe, comprising the steps of:
providing a repair liner for repairing a lateral/main pipe junction, the repair liner including a radio-frequency identification transponder capable of transmitting an identification signal that is unique to the repair liner;
bonding the repair liner to one or both of lateral and main sewer pipes at a lateral/main pipe junction, whereby the radio-frequency identification transponder is positioned proximate the lateral/main pipe junction;
providing a mobile device for moving in the main sewer pipe, the mobile device including a radio-frequency identification reader capable of detecting the identification signal transmitted by the radio-frequency identification transponder when the mobile device is positioned proximate the radio-frequency identification transponder; and
moving the mobile device in the main sewer pipe so that the mobile device is positioned proximate the radio-frequency identification transponder so as to detect the identification signal transmitted by the RFID transponder.

2. The method of claim 1, wherein the mobile device is a packer for applying a repair liner to a lateral/main pipe junction.

3. The method of claim 1, wherein the repair liner is made of a flexible material impregnated with an uncured resinous material capable of curing and hardening to thereby bond the repair liner to one or both of lateral and main sewer pipes.

4. The method of claim 3, wherein the repair liner comprises a cylindrical sleeve for lining a circumferential portion of the lateral sewer pipe, and an annular collar projecting radially outwardly from the sleeve for lining a portion of the main pipe proximate the main/lateral junction.

5. The method of claim 4, wherein the radio-frequency identification transponder is disposed on the annular collar of the repair liner.

6. The method of claim 5, wherein the radio-frequency identification transponder is secured to a surface of the repair liner.

7. The method of claim 5, wherein the radio-frequency identification transponder is embedded within the flexible material of the repair liner.

8. The method of claim 3, wherein the repair liner comprises a cylindrical sleeve for lining a circumferential portion of the lateral sewer pipe, and a cylindrical sleeve for lining a circumferential portion of the main pipe proximate the main/lateral junction.

9. The method of claim 8, wherein the radio-frequency identification transponder is disposed on the cylindrical sleeve for lining a circumferential portion of the main pipe.

10. The method of claim 9, wherein the radio-frequency identification transponder is secured to a surface of the repair liner.

11. The method of claim 9, wherein the radio-frequency identification transponder is embedded within the flexible material of the repair liner.

12. A repair liner for repairing a lateral/main pipe junction, the repair liner including a radio-frequency identification transponder capable of transmitting an identification signal that is unique to the repair liner.

13. The repair liner of claim 12, wherein the repair liner is made of a flexible material impregnable with an uncured resinous material capable of curing and hardening to thereby bond the repair liner to one or both of lateral and main sewer pipes.

14. The repair liner of claim 13, wherein the repair liner comprises a cylindrical sleeve for lining a circumferential portion of the lateral sewer pipe, and an annular collar projecting radially outwardly from the sleeve for lining a portion of the main pipe proximate the main/lateral junction.

15. The repair liner of claim 14, wherein the radio-frequency identification transponder is disposed on the annular collar of the repair liner.

16. The repair liner of claim 14, wherein the radio-frequency identification transponder is secured to a surface of the repair liner.

17. The repair liner of claim 16, wherein the radio-frequency identification transponder is embedded within the flexible material of the repair liner.

18. The repair liner of claim 13, wherein the repair liner comprises a cylindrical sleeve for lining a circumferential portion of the lateral sewer pipe, and a cylindrical sleeve for lining a circumferential portion of the main pipe proximate the main/lateral junction.

19. The repair liner of claim 18, wherein the radio-frequency identification transponder is disposed on the cylindrical sleeve for lining the circumferential portion of the main pipe.

20. The repair liner of claim 19, wherein the radio-frequency identification transponder is secured to a surface of the repair liner.

21. The repair liner of claim 19, wherein the radio-frequency identification transponder is embedded within the flexible material of the repair liner.
